(19) United States
(12) Patent Application Publication
(10) Pub. No.: US 2001/0017753 A1
(43) Pub. Date: Aug. 30, 2001

(54) MAGNETORESISTIVE EFFECT FILM, MANGETORESISTIVE EFFECT SENSOR UTILIZING THE SAME AND MAGNETIC STORAGE DEVICE

(76) Inventors: SHIGERU MORI, TOKYO (JP); KAZUHIKO HAYASHI, TOKYO (JP); MASAFUMI NAKADA, TOKYO (JP)

Correspondence Address: LAW OFFICES, FOLEY & LARDNER, 3000 K STREET NW, SUITE 500 PO BOX 25696, WASHINGTON, DC, 200078696

(21) Appl. No.: 09/143,546

(22) Filed: Aug. 28, 1998

(30) Foreign Application Priority Data
Aug. 29, 1997 (JP) 9-235108

(51) Int. Cl. G11B 5/39

(52) U.S. Cl. 360/324.12

(57) ABSTRACT

A magnetoresistive effect film achieves sufficiently large resistance variation ratio, sufficient switch connection force from an anti-ferromagnetic layer to a fixed magnetic layer, certainly maintains head resistance at a temperature higher than or equal to 200° C. with certainly maintaining good soft magnetic characteristics of NiFe layer or NiFe layer/CoFe layer, and is superior in thermal stability and has large magnetoresistance variation ratio (MR ratio). The magnetoresistive effect film is a stacked film which is consisted of a substrate, an buffer layer, a NiFe layer, a non-magnetic layer, a fixed magnetic layer, and an anti-ferromagnetic layer. A crystal grain size of the stacked film is greater than or equal to 8 nm and less than or equal to a total layer thickness of the stacked layer excluding the substrate and the buffer layer.

### BACKGROUND OF THE INVENTION

1. Field of the Invention

The present invention relates to a magnetoresistive effect film, a magnetoresistive effect sensor utilizing the magnetoresistive effect film and a magnetic storage device. More particularly, the invention relates to a magnetoresistive effect film having a basic structure of substrate/buffer layer/NiFe layer/non-magnetic layer/fixed magnetic layer/anti-ferromagnetic layer, a magnetoresistive effect sensor utilizing the magnetoresistive effect film and a magnetic storage device.

2. Description of the Related Art

Conventionally, a magnetic scanning converter called as a magnetoresistive (MR) sensor or head has been known, which can detect signals from a magnetic storage medium with a high linear density. The MR sensor detects a magnetic field signal on the basis of an intensity of a magnetic field sensed by a scanning element and variation of resistance as a function of direction. Such conventional MR sensor operates according to an anisotropic magetoresistive (AMR) effect, in which one component of a resistance of the scanning element varies proportional to square of cosine of an angle between a direction of magnetization and direction of a sensed electric current flowing through the element. More detailed explanation of the AMR effect has been disclosed in D. A. Thompson et al., “Thin Film Magnetoresistics in Memory, Storage and Related Applications”, IEEE Trans. on Mag., MAG-11, p.1039 (1975). In the magnetic head employing the AMR effect, a longitudinal bias is frequently applied for suppressing Barkhausen noise. As a material for applying longitudinal bias, anti-ferromagnetic material, such as FeMn, NiMn, nickel oxide and the like can be used.

Furthermore, recently, there has been reported more remarkable effect that variation of resistance of a stacked magnetic sensor depends upon a spin dependent transmission of a conduction electron between magnetic layers via a non-magnetic layer and a spin dependent scattering at a layer interface associating therewith. The magnetoresistive effect is called various names, such as “giant magnetoresistive effect”, “spin valve effect” and so forth. Such MR sensor is formed of a predetermined material to achieve improved sensitivity higher than that observed in sensors employing AMR effect and large resistance variation. In the MR sensor of this kind, an in-plane resistance between a pair of ferromagnetic layers separated by a non-magnetic layer varies proportional to a cosine of an angle between magnetizing directions of two ferromagnetic layers.

In Japanese Unexamined Patent Publication No. Heisei 2-61572, a stacked magnetic structure causing high MR variation depending upon non-parallel alignment of magnetization in the magnetic layer, has been disclosed. As a material useful for static structure, ferromagnetic transition metal and alloy are listed in the above-mentioned publication. On the other hand, there has been disclosed that a structure, in which an anti-ferromagnetic layer is added to at least one of two ferromagnetic layers separated by an intermediate layer and FeMn as anti-ferromagnetic material are appropriate.

In Japanese Unexamined Patent Publication No. Heisei 4-358310, there has been disclosed a MR sensor independent of a direction of a current flowing through the sensor, which MR sensor has two thin film layers of ferromagnetic material separated by a thin film layer of non-magnetic metal, and in which magnetizing directions of two ferromagnetic thin film layers are orthogonal when an applied magnetic field is zero, a resistance between two non-coupled ferromagnetic layers is varied proportional to cosine of an angle between magnetizing directions of two layers.

In Japanese Unexamined Patent Publication No. Heisei 6-203340, there has been disclosed a MR sensor based on the foregoing effect, which includes two ferromagnetic thin film separated by a non-magnetic metal material thin film, and in which a magnetizing direction of an adjacent anti-ferromagnetic layer is maintained perpendicular to another ferromagnetic layer when an externally applied magnetic field is zero.

In Japanese Unexamined Patent Publication No. Heisei 7-262529, there is disclosed a magnetoresistive effect layer which is a spin valve having a structure of first magnetic layer/non-magnetic layer/second magnetic layer/anti-ferromagnetic layer, and particularly the structure employing CoZrNb, CoZrMo, FeSiAl, FeSi, NiFe or those added Cr, Mn, Pt, Ni, Cu, Ag, Al, Ti, Fe, Co, Zn as a material of the first and second magnetic layers.

In Japanese Unexamined Patent Publication No. Heisei 7-202292, there is disclosed a magnetoresistive effect layer consisted of a plurality of magnetic films stacked on a substrate via a non-magnetic layer in which an anti-ferromagnetic film is provided adjacent one of soft magnetic films adjacent via a non-magnetic film. In the magnetoresistive effect layer, in which, assuming a bias magnetic field of the anti-ferromagnetic layer being Hr and coercivity of another soft magnetic field being Hc₂, Hc₂<Hr is established, the anti-ferromagnetic material is at least one of NiO, CoO, FeO, Fe₂O₃, MnO, Cr or mixture thereof.

In Japanese Unexamined Patent Publication No. Heisei 8-127864, there is disclosed a magnetoresistive effect layer, which is at least two super lattice, in which anti-ferromagnetic material is consisted at least two selected among NiO, Niₓ, Co₁₋ₓ, CoO.

In Japanese Unexamined Patent Publication No. Heisei 8-204253, there is disclosed a magnetoresistive effect layer which is a super lattice, in which anti-ferromagnetic material is consisted of at least two selected among NiO, Niₓ, Co₁₋ₓO (x=0.1 to 0.9), CoO, and an atomic ratio of Ni in the super lattice versus Co is greater than or equal to 1.0.

On the other hand, in Japanese Unexamined Patent Publication No. Heisei 9-50611, there is disclosed a magnetoresistive effect layer, in which the anti-ferromagnetic body is a two layer film stacked 1 to 4 nm of CoO on NiO.

In the magnetoresistive effect layer having a basic structure of substrate/buffer layer/NiFe layer/CoFe layer/non-magnetic layer/fixed magnetic layer/anti-ferromagnetic layer, there is a reported example in the case where the buffer layer is Ta of 5 nm, NiFe layer is NiFe of 3.5 nm, CoFe layer is Co₉₀Fe₁₀ of 4 nm, non-magnetic layer is Cu of 3.2 nm, the fixed magnetic layer is Co₉₀Fe₁₀ of 4 nm, and anti-ferromagnetic layer is FeMn of 10 nm, in Abstract of 20th Meeting of Magnetics Society of Japan, p265.

However, in case of most magnetoresistive effect layers having basic structure of substrate/buffer layer/NiFe layer/CoFe layer/non-magnetic layer/fixed magnetic layer/anti-ferromagnetic layer of the conventional type, heat treatment at a temperature higher than or equal to 200° C. for providing a exchange bias from the anti-ferromagnetic layer to the fixed magnetic layer. Here, an interface between the non-magnetic layer, and NiFe layer/CoFe layer and the fixed magnetic layer affects for scattering condition of the conductive electron and is associated with a resistance variation ratio to cause disturbance of interface by the heat treatment and thus to cause difficulty in obtaining sufficiently large resistance variation ratio. On the other hand, even in the magnetoresistive effect layer employing the anti-ferromagnetic material which does not require heat treatment for providing exchange bias, upon actually preparing a recording and reproducing head, a process step of hardening a resist in a step of fabricating a writing head portion, is inherent. In this process step, heat treatment at a temperature higher than or equal to 200° C. becomes necessary. Therefore, by this heat treatment, resistance variation ratio of the magnetoresistive effect layer is significantly lowered to make it impossible to obtain an output value as designed.

More particularly, when the buffer layer is not present or when an appropriate buffer layer is not employed, crystallinity of NiFe layer/CoFe layer/non-magnetic layer/fixed magnetic layer/anti-ferromagnetic layer becomes low to make crystal grain size small. At this time, it is not possible to obtain sufficient magnitude of exchange bias applied from the anti-ferromagnetic layer to the fixed magnetic layer. On the other hand, in a condition of interface between the CoFe layer and the non-magnetic layer, namely, an interface roughness or a mixing condition of the interface is not appropriate, variation amount of the magnetic resistance of the sufficient value cannot be obtained. When the recording and reproducing system is constructed, sufficient reproduction output cannot be obtained. Furthermore, since the crystal grain size is small, variation of the condition of the interface between the CoFe layer and the non-magnetic layer is easily caused due to heat treatment to cause significant reduction of variation amount of the magnetoresistance by heat treatment. Furthermore, in a performance between the magnetoresistive layers after heat treatment, fluctuation can be easily caused to make it difficult to obtain the magnetoresistive effect film having the same performance. Therefore, employing such stacked layer in the recording and reproducing head requiring heat treatment at a temperature higher than or equal to 200° C., a problem is encountered in view of reproducing output and stability.

### SUMMARY OF THE INVNTION

The present invention has been worked out for solving the problems in the prior art as set forth above. Therefore, it is an object of the present invention to provide a magnetoresistive effect film achieving sufficiently large resistance variation ratio, exchange bias from an anti-ferromagnetic layer to a fixed magnetic layer, to certainly provide heat resistance at a temperature higher than or equal to 200° C. with certainly providing good soft magnetic characteristics of NiFe layer or NiFe layer/CoFe layer, having superior thermal stability and large magnetoresistive variation ratio (MR ratio), magnetoresistive effect sensor having high sensitivity utilizing the magnetoresistive effect film, and a magnetic storage device.

According to the first aspect of the present invention, a magnetoresistive effect film comprising a stacked film is consisted of:

a substrate,

an buffer layer,

a NiFe layer,

a non-magnetic layer,

a fixed magnetic layer, and

an anti-ferromagnetic layer,

a crystal grain size of the stacked film being greater

than or equal to 8 nm and less than or equal to a total layer thickness of the stacked layer excluding the substrate and the buffer layer.

The stacked layer may be further consisted of a CoFe layer and/or a magnetoresistance enhanced layer.

The buffer layer may contain at least one of Ta, Zr, Hf and W.

According to the second aspect of the present invention, a magnetoresistive effect sensor comprises:

a substrate,

a lower shield layer,

a lower gap layer and

a magnetoresistive effect film of a stacked film consisted of a substrate, an buffer layer, a NiFe layer, a non-magnetic layer, a fixed magnetic layer, and an anti-ferromagnetic layer, and a crystal grain size of the stacked film being greater than or equal to 8 nm and less than or equal to a total layer thickness of the stacked layer excluding the substrate and the buffer layer,

the lower shield layer and the magnetoresistive effect film being patterned;

a longitudinal bias layer and a lower electrode layer being stacked at a position contacting with at least an end portion of the magnetoresistive effect film, in sequential order, and

an upper gap layer and an upper field being stacked on the longitudinal bias layer and the lower electrode layer in sequential order.

A gap defining insulation layer may be disposed between the magnetoresistive effect film and the upper gap layer.

According to the third aspect of the present invention, a magnetoresistive effect sensor comprising:

a substrate,

a lower shield layer,

a lower gap layer and

a magnetoresistive effect film of a stacked film consisted of a substrate, an buffer layer, a NiFe layer, a non-magnetic layer, a fixed magnetic layer, and an anti-ferromagnetic layer, and a crystal grain size of the stacked film being greater than or equal to 8 nm and less than or equal to a total layer thickness of the stacked layer excluding the substrate and the buffer layer,

the lower shield layer and the magnetoresistive effect film being patterned;

a longitudinal bias layer and a lower electrode layer being stacked at a position overlapping with a part of the magnetoresistive effect film, in sequential order, and

an upper gap layer and an upper field being stacked on the longitudinal bias layer and the lower electrode layer in sequential order.

According to the fourth aspect of the present invention, a magnetic storage device comprises:

a magnetic storage medium;

a magnetic head for recording and reproducing data in and from sad magnetic storage medium;

a positioning mechanism for positioning the magnetic head on a predetermined track of the magnetic storage medium; and

a control portion controlling respective components of the magnetic storage device, and

the magnetic head including a magnetoresistive effect sensor comprising a substrate, a lower shield layer, a lower gap layer and a magnetoresistive effect film of a stacked film consisted of a substrate, an buffer layer, a NiFe layer, a non-magnetic layer, a fixed magnetic layer, and an anti-ferromagnetic layer, and a crystal grain size of the stacked film being greater than or equal to 8 nm and less than or equal to a total layer thickness of the stacked layer excluding the substrate and the buffer layer, the lower shield layer and the magnetoresistive effect film being patterned, a longitudinal bias layer and a lower electrode layer being stacked at a position contacting with at least an end portion of the magnetoresistive effect film, in sequential order, and an upper gap layer and an upper field being stacked on the longitudinal bias layer and the lower electrode layer in sequential order.

According to the fifth aspect of the present invention, a magnetic storage device comprises:

a magnetic storage medium;

a magnetic head for recording and reproducing data in and from sad magnetic storage medium;

a positioning mechanism for positioning the magnetic head on a predetermined track of the magnetic storage medium; and

a control portion controlling respective components of the magnetic storage device, and

the magnetic head including a magnetoresistive effect sensor comprising a substrate, a lower shield layer, a lower gap layer and a magnetoresistive effect film of a stacked film consisted of a substrate, an buffer layer, a NiFe layer, a non-magnetic layer, a fixed magnetic layer, and an anti-ferromagnetic layer, and a crystal grain size of the stacked film being greater than or equal to 8 nm and less than or equal to a total layer thickness of the stacked layer excluding the substrate and the buffer layer, the lower shield layer and the magnetoresistive effect film being patterned, a longitudinal bias layer and a lower electrode layer being stacked at a position overlapping with a part of the magnetoresistive effect film, in sequential order, and an upper gap layer and an upper field being stacked on the longitudinal bias layer and the lower electrode layer in sequential order.

A gap defining insulation layer may be disposed between the magnetoresistive effect film and the upper gap layer.

Hereinafter, while effect of the magnetoresistive effect film according to the present invention will be discussed in terms of a construction consisted of the substrate/the buffer layer/NiFe layer/the CoFe layer/the non-magnetic layer/the fixed magnetic layer/the anti-ferromagnetic layer, similar or substantially comparable effect may be achieved with other construction of the magnetoresistive effect film as set forth above.

When Ta, Zr, Hf, W or the like is used in the buffer layer, crystallinity of NiFe layer/CoFe layer/non-magnetic layer/fixed magnetic layer/anti-ferromagnetic layer can be enhanced and to make crystal grain size greater. At first, a typical x-ray diffraction chart in the case where Ta is used as the buffer layer and FeMn is used as the anti-ferromagnetic layer, is shown in FIG. 9. A peak appears corresponding to (111) plane of a fcc structure of the stacked film having a structure of Ni/Fe layer/CoFe layer/non-magnetic layer/fixed magnetic layer. The similar peak appears in other structure of the stacked films set forth above. The peak is caused due to diffraction from the maximum density surface of the stacked film and reflects crystal grain size. At this time, the buffer layer does not appear on the x-ray diffraction chart for amorphous structure. FIG. 10 shows correlation between the layer thickness of the buffer layer and the crystal grain size of the stacked film in the case where Ta (0.4 to 10 nm) is used in the buffer layer. As increasing of the layer thickness of the buffer layer, the crystal grain size of the stacked film is increased. Thus, it can be appreciated that the significant correlation between the crystal grain size of the stacked film and the layer thickness of the buffer layer. This tendency can be seen even when Zr, Hf, W or the like is employed.

Next, a relationship between the crystal grain size and the magnetoresistive effect film employing Ta (0.2 to 50 nm), Zr (0.2 to 30 nm), Hf (0.2 to 20 nm) has been checked. At this time, 1.1 mm thick Corning 7059 glass substrate as the substrate, 4 nm of Ni₈₁Fe₁₉ (at%) as the NiFe layer, 3 nm of Co₉₀Fe₁₀ (at%) as the CoFe layer, 2.5 nm of Cu as the non-magnetic layer, 3 nm of Co₉₀Fe₁₀ (at%) of the fix4ed magnetic layer, 10 nm of FeMn as the anti-ferromagnetic layer, and 2.5 nm of Cu as the protective layer are employed. After deposition of the films, heat treatment at 260° C. under less than or equal to 4×10⁻⁵ Pa of pressure and 500 Oe of the magnetic field for four hours was effected as required for fabrication of the recording and reproducing head. FIG. 11 shows a correlation between the crystal grain size and the MR ratio after heat treatment standardized by a value f the MR ratio before heat treatment. The magnetoresistive effect film having the crystal grain size greater than or equal to 8 nm holds the MR ratio higher than or equal to about 90% before the heat treatment even after heat treatment. Thus, by setting the crystal grain size of the magnetoresistive effect film greater than or equal to 8 nm, reduction of the MR ratio due to heat treatment can be restricted. Furthermore, it can be appreciated that fluctuation of variation of the MR ratio after heat treatment becomes smaller in comparison with the magnetoresistive effect film having the crystal grain size smaller than 8 nm. On the other hand, when the crystal grain size of the stacked film is about equal to the overall layer thickness of the stacked film excluding the substrate and the undercoat, dependency of the crystal grain size in view of the heat resistance and stability can be avoided. Therefore, the magnetoresistive effect film superior in heat resistance and stability can be obtained by setting the crystal grain size of the stacked film at less than or equal to the overall thickens of the stacked film excluding the substrate and the buffer layer and greater than or equal to 8 nm.

On the basis of new finding obtained as a result of study as set forth above, in a stacked layer having a structure of substrate/buffer layer/NiFe layer/CoFe layer/non-magnetic layer/fixed magnetic layer/anti-ferromagnetic layer, the magnetoresistive effect film having sufficiently large MR ratio even after heat treatment at a temperature higher than or equal to 200° C. can be attained by setting the crystal grain size greater than or equal to 8 nm and less than or equal to overall thickness of the stacked layer excluding the substrate and the buffer layer. Also, since fluctuation between the element becomes small, sufficient reproduction output and stability can be obtained when the recording and reproducing system is established with employing such magnetoresistive effect film.

### BRIEF DESCRIPTION OF THE DRAWINGS

The present invention will be understood more fully from the detailed description given herebelow and from the accompanying drawings of the preferred embodiment of the present invention, which, however, should not be taken to be limitative to the invention, but are for explanation and understanding only.

In the drawings:

FIG. 1 is an illustration showing a typical structure of a magnetoresistive effect film according to the present invention;

FIG. 2 is an illustration showing a typical construction of a magnetoresistive (MR) sensor;

FIG. 3 is an illustration showing a typical construction of a magnetoresistive (MR) sensor;

FIG. 4 is an illustration showing a construction of the major part of a recording and reproducing head;

FIG. 5 is an illustration showing a general construction of a magnetic recording and reproducing apparatus;

FIG. 6 is an illustration showing a typical construction of the magnetoresistive effect film;

FIG. 7 is an illustration showing a typical construction of the magnetoresistive effect film;

FIG. 8 is an illustration showing a typical construction of the magnetoresistive effect film;

FIG. 9 is a diagrammatic illustration showing an X-ray diffraction curve in a stacked layer of FIG. 1;

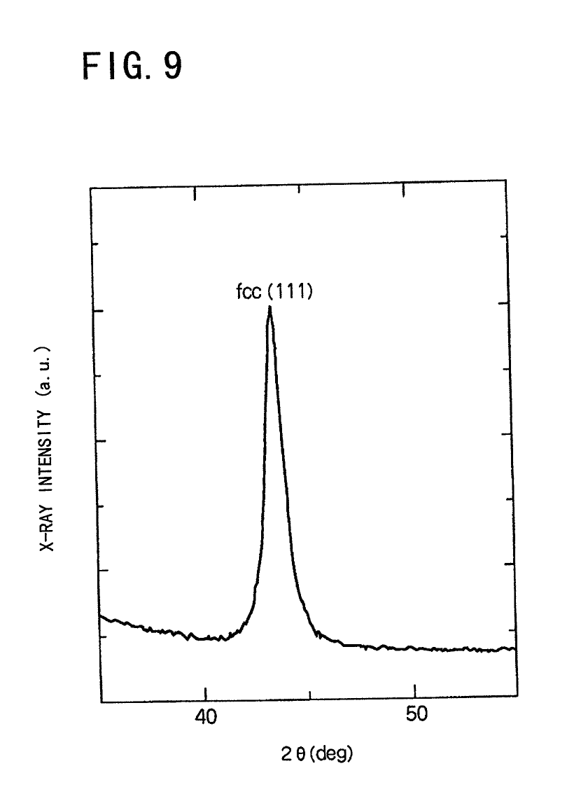

FIG. 10 is a diagrammatic illustration showing a relationship between a thickness of Ta buffer layer and a crystal grain size of the stacked layer; and

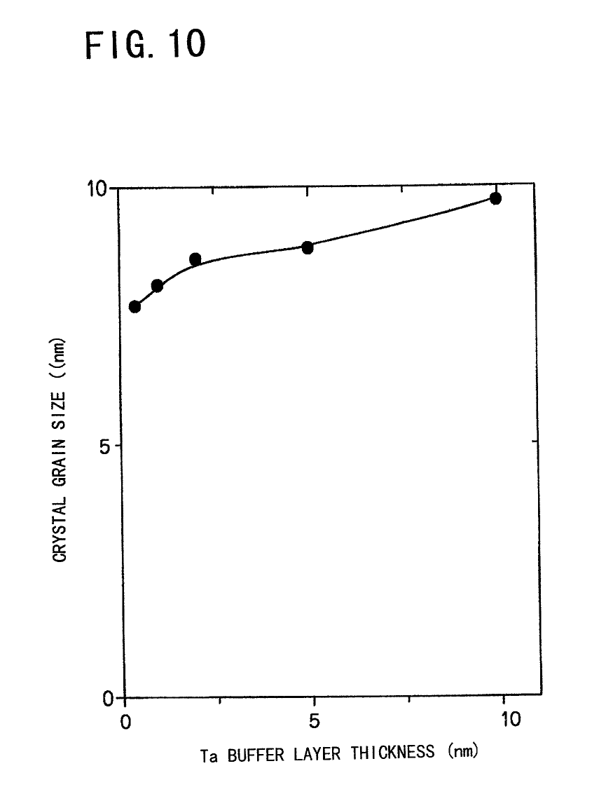

FIG. 11 is a diagrammatic illustration showing a relationship between a crystal grain size of the stacked layer and a MR ratio after heat treatment/MR ratio before heat treatment.

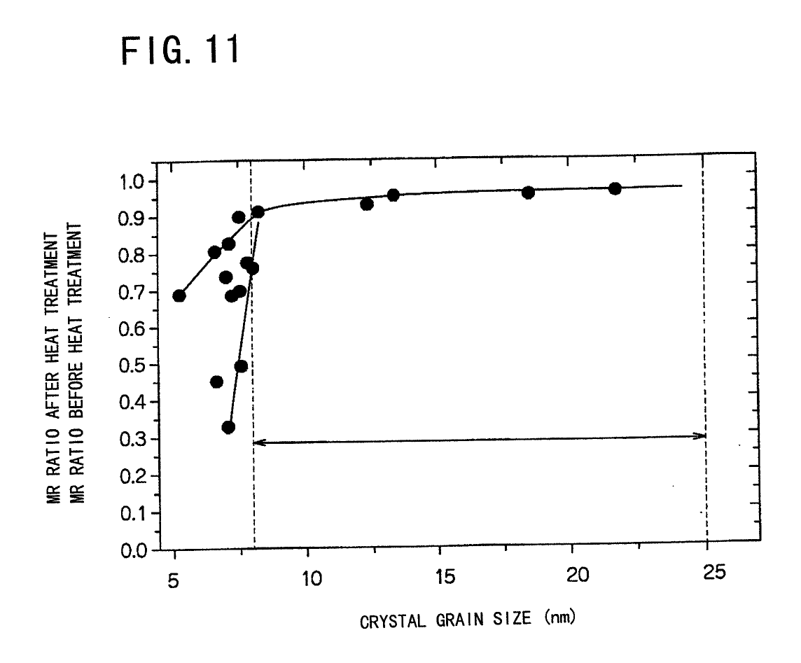

### DESCRIPTION OF THE PREFERRED EMBODIMENT

The present invention will be discussed hereinafter in detail in terms of the preferred embodiment of the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to avoid unnecessarily obscure the present invention.

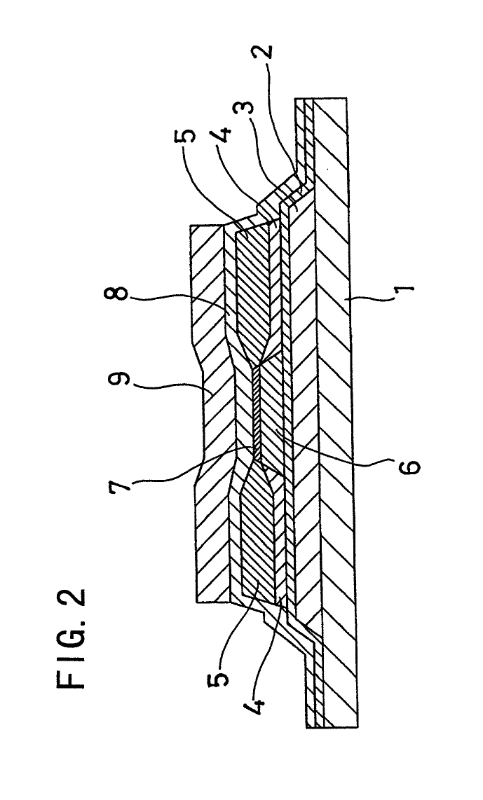

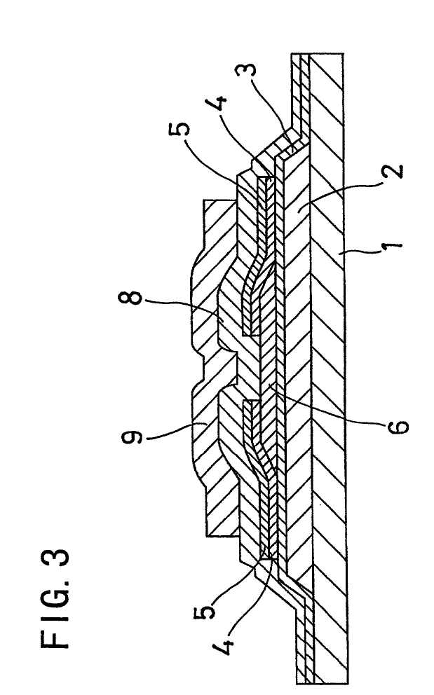

As a shield type element, to which the present invention is applied, an element of the type shown in FIGS. 2 and 3 can be employed.

In an element of the type shown in FIG. 2, a lower shield layer 2, a lower gap layer 3 and a magnetoresistive effect film 6 are stacked on a substrate 1. A gap defining insulation layer 7 may also be stacked thereon, as required. The shield layer 2 is frequently patterned into an appropriate size through a photoresist (PR) etching process. The magnetoresistive effect film 6 is patterned into an appropriate size and shape through the PR etching process. At a position contacting with the end portion of the magnetoresistive effect film 6, a longitudinal bias layer 4 and a lower electrode layer 5 are stacked in sequential order. A gap layer 8 and an upper shield layer 9 are stacked over the lower electrode layer 5 in sequential order.

In an element of the type shown in FIG. 3, the lower shield layer 2, the lower gap layer 3 and the magnetoresistive effect film 6 are stacked on the substrate 1. The shield layer 2 is frequently patterned into an appropriate size through PR etching process. The magnetoresistive effect film 6 is patterned into an appropriate size through the PR etching process. On the magnetoresistive effect film 6, the longitudinal bias layer 4 and the lower electrode 5 are stacked in sequential order so as to partly overlap therewith. On the lower electrode layer 5, the upper gap layer 8 and the upper shield layer 9 are stacked in sequential order.

As the lower shield layer of the elements of he types shown in FIGS. 2 and 3, NiFe, CoZr or CoFeB, CoZrMo, CoZrNb, CoZr, CoZrTa, CoHf, CoTa, CoTaHf, CoNbHf, CoZrNb, CoHfPd, CoTaZrNb, CoZrMoNi alloy, FeAlSi, nitriding iron type material and the like may be used. A layer thickness of the lower shield layer may be within a range of 0.3 to 10 μm. The lower gap layer may be formed of SiO₂, aluminum nitride, silicon nitride, diamond-like carbon or the like in addition to alumina. A layer thickness of the lower gap layer may be within a range of 0.01 to 0.20 μm. The lower electrode layer may be formed of Zr, Ta or Mo as simple substance, alloy thereof, or mixture thereof. A layer thickness may be within a range of 0.01 to 0.10 μm. The longitudinal bias layer may be formed of CoCrPt, CoCr, CoPt, CoCrTa, FeMn, NiMn, IrMn, PtPdMn, ReMn, PtMn, CrMn, Ni oxide, a mixture of Ni oxide and Co oxide, a mixture of Ni oxide and Fe oxide, a two layer film of Ni oxide/Co oxide, a two layer film of Ni oxide/Fe oxide. The gap defining insulation layer is formed of alumina, SiO₂, aluminum nitride, silicon nitride, diamond-like carbon or the like. A layer thickness is desirably in a range of 0.005 to 0.05 μm. The upper gap layer may be formed of alumina, SiO₂, aluminum nitride, silicon nitride, diamond-like carbon and the like. A layer thickness of the upper gap layer is desirably in a range of 0.01 to 0.20 μm. The upper shield layer may be formed of NiFe, CoZr or CoFeB, CoZrMo, CoZrNb, CoZr, CoZrTa, CoHf, CoTa, CoTaHf, CoNbHf, CoZrNb, CoHfPd, CoTaZrNb, CoZrMoNi alloy, FeAlSi, nitriding iron type material and the like may be used. A layer thickness of the upper shield layer may be within a range of 0.3 to 10 μm.

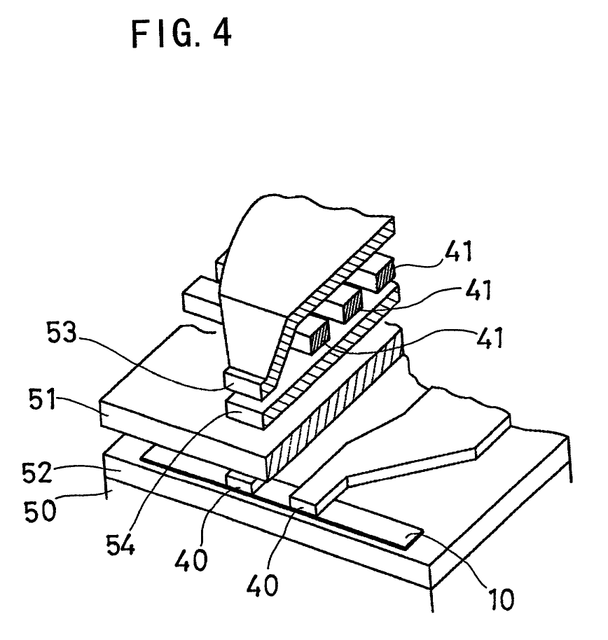

Such magnetoresistive effect sensor may be used as an integrated type recording and reproducing head by forming a writing head portion with an inductive coil. FIG. 4 is a conceptual illustration of the recording and reproducing head. The recording and reproducing head is consisted of a reproducing head employing the element of the present invention and an inductive type recording head. While the shown embodiment is directed to the recording head for longitudinal recording, it may be possible to adapt for a perpendicular recording by combining the magnetoresistive effect film according to the present invention with a perpendicular recording head. The head is consisted of a reproducing head including a lower shield film 52, the magnetoresistive effect film 10 and an electrode 40, an upper shield film 51, and a recording head including a lower magnetic film 54, a coil 41 and an upper magnetic film 53. In this case, it is possible to replace the upper shield film 51 and the lower magnetic film 54 with a common film. By this head, a signal is written on a recording medium, and a signal is read out from the recording medium. A sensing portion of the reproducing head and a magnetic gap of the recording head can be simultaneously positioned on the same track by forming them in a overlapping position on the same slider, as set forth above. This head is machined into a slider and mounted on a magnetic recording and reproducing apparatus.

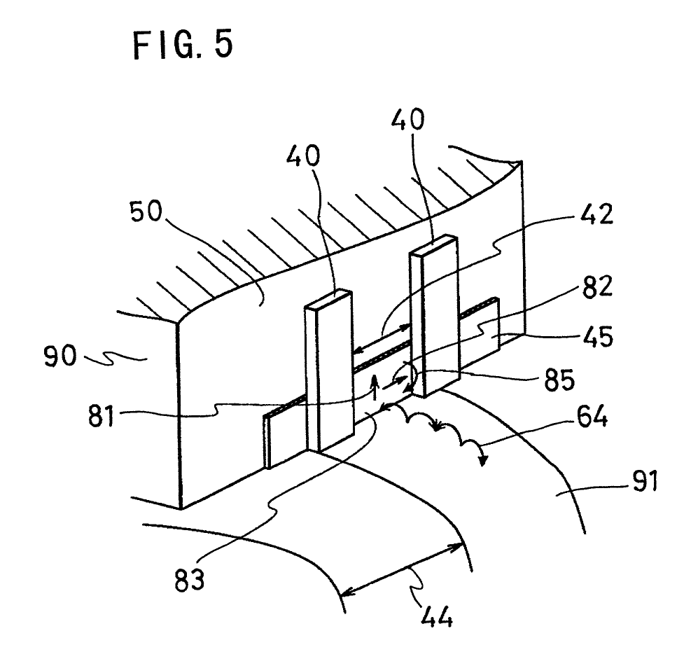

FIG. 5 is an illustration showing a construction of the major portion of a magnetic recording and reproducing apparatus employing the magnetoresistive effect film according to the present invention. On the substrate 50 also serving as a head slider 90, a magnetoresistive effect film 45 and an electrode film 40 are formed. Reproduction is performed by positioning the head slider 90 with the magnetoresistive effect film 45 and the electrode film 40 on a recording medium 91. The recording medium 91 is rotated. The head slider 90 opposes with the recording medium 91 with a clearance less than or equal to 0.2 μm or in contact and causes relative motion with the rotating recording medium. With this mechanism, the magnetoresistive effect film 45 can be set at a position, in which a magnetic signal recorded on the recording medium 91 can be read from a magnetic field leakage. Other construction of the shown embodiment of the magnetic recording and reproducing apparatus may be any constructions known in the conventional magnetic recording and reproducing apparatus.

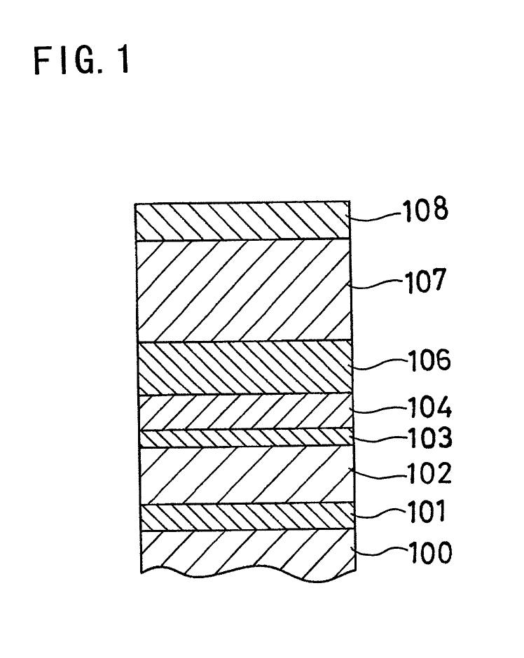

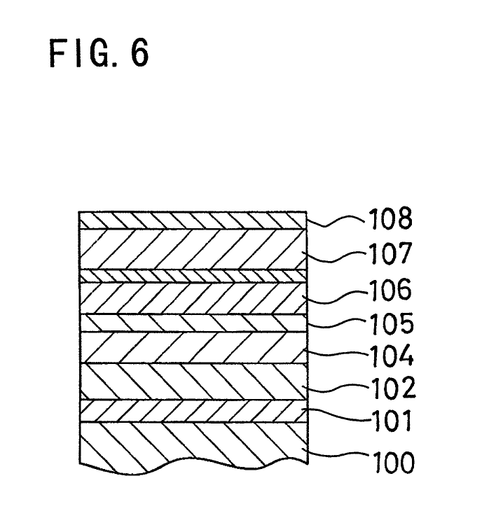

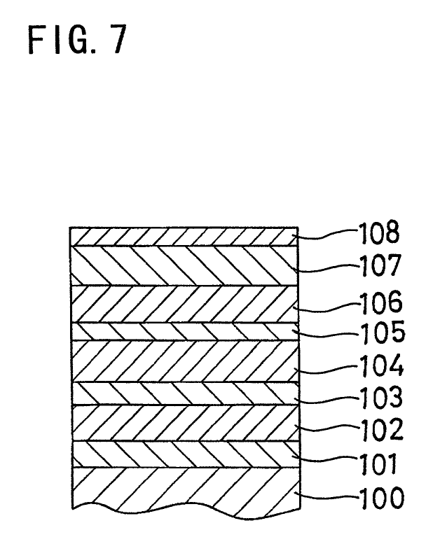

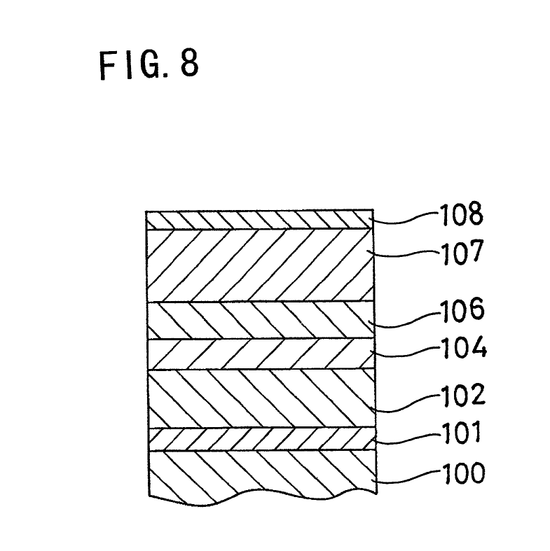

FIGS. 1 and 6 to 8 are illustration showing a general construction of a film structure of the magnetoresistive effect film to be employed in the shown embodiment. An embodiment shown in FIG. 1 has a structure, in which an buffer layer 101, a NiFe layer 102, a CoFe layer 103, a non-magnetic layer 104, a fixed magnetic layer 106, an anti-ferromagnetic layer 107 and a protective layer 108 are stacked on a substrate 100 in sequential order. An embodiment shown in FIG. 6 has a structure, in which the buffer layer 101, the NiFe layer 102, the non-magnetic layer 104, an MR enhanced layer 105, the fixed magnetic layer 106, the anti-ferromagnetic layer 107 and the protective layer 108 are stacked on the substrate 100 in sequential order. An embodiment shown in FIG. 7 has a structure, in which the buffer layer 101, the NiFe layer 102, the CoFe layer 104, the non-magnetic layer 104, an MR enhanced layer 105, the fixed magnetic layer 106, the anti-ferromagnetic layer 107 and the protective layer 108 are stacked on the substrate 100 in sequential order. An embodiment shown in FIG. 8 has a structure, in which the buffer layer 101, the NiFe layer 102, the non-magnetic layer 104, the fixed magnetic layer 106, the anti-ferromagnetic layer 107 and the protective layer 108 are stacked on the substrate 100 in sequential order.

As a material of the buffer layer, Ta, Zr, Hf, W and the like is preferred. Crystallity of stacked film stacked on the buffer layer is good. A layer thickness of the buffer layer is not specified. However, when the buffer layer is excessively thick, a ratio of current flowing through the buffer layer becomes large to make MR ratio smaller. Therefore, it is preferred that the layer thickness of the buffer layer is less than or equal to 100 nm. As a material of the NiFe layer, it is preferred have about 78 to 84 at% of Ni composition. A layer thickness of the NiFe layer is preferably in a range of about 1 to 10 nm. As a material of the CoFe layer, it is preferred to have about 86 to 99 at% of Co composition. A preferred layer thickness of the CoFe layer is in a range of about 0.1 to 5 nm. As a material of the non-magnetic layer, Cu, a material, in which about 1 to 20 at% of Ag is added to Cu, a material, in which about 1 to 20 at% of Re is added to Cu, Cu-Au alloy may be used. A layer thickness of the non-magnetic layer is preferably in a range of 2 to 4 nm. As a material of the MR enhanced layer, Co, NiFeCo, FeCo or the like or CoFeB, CoZrMo, CoZrNb, CoZr, CoZrTa, CoHf, CoTa, CoTaHf, CoNbHf, CoZrNb, CoHfd, CoTaZrNb, CoZrMoNi alloy or amorphous magnetic material may be used. A preferred layer thickness is about 0.5 to 5 nm. When the MR enhanced layer is not employed, an MR ratio is slightly lowered in comparison with the case where the MR enhanced layer is employed. However, process step in fabrication can be reduced correspondingly. As a material of the fixed magnetic layer, simple substance, alloy, or stacked layer of a group based on Co, Ni, Fe is employed. A layer thickness of the fixed material layer is preferred in a range of about 1 to 50 nm. As a material of the anti-ferromagnetic layer, FeMn, NiMn, IrMn, PtPdMn, ReMn, PtMn, CrMn, Ni oxide, a mixture of Ni oxide and Co oxide, a mixture of Ni oxide and Fe oxide, a two layer film of Ni oxide/Co oxide, two layer film of Ni oxide/Fe oxide or the like may be used. As a material of the protective layer, an oxide or nitride of a group consisted of Al, Si, Ta, Ti or a group consisted of Cu, Au, Ag, Ta, Hf, Zr, Ir, Si, Ti, Cr, A I, C, or mixture thereof. When the protective layer is employed, corrosion resistance is improved, whereas number of process steps in fabrication process is reduced to improve productivity when the protective layer is not employed.

A stacked film having the construction set forth above, a crystal grain size is greater than or equal to 8 nm and is less than or equal to a total layer thickness of the stacked layer except for the substrate/buffer layer. The stacked layer referred to in the foregoing first aspect of the present invention represents overall layers except for the substrate and the buffer layer. As the crystal grain size, a value derived from an x-ray diffraction peak and a relational expression [GottingenNachr. 98(1918)] of the crystal grain size shown by P. Scherrer using an angle of maximum density surface reflection peak observed in an x-ray diffraction curve of the stacked film and a half value width.

In a construction shown in FIG. 1, the magnetoresistive effect film is fabricated with employing a glass substrate of Corning 7059 (tradename) of 1.1 mm thick as the substrate 100, 5 nm of Ni₈₁Fe₁₉ (at%) as the NiFe layer, 3 nm of Co₉₀Fe₁₀ (at%) as the CoFe layer 103, 2.5 nm of Cu as the non-magnetic layer 104, 3 nm of Co₉₀Fe₁₀ (at%) as the fixed magnetic layer 106, 10 nm of FeMn as the anti-ferromagnetic layer 107, and 2.5 nm of Cu as the protective layer 108. Compositions of respective layers represent analytical value of a target upon deposition by sputtering (containing ±0.5% of analyzing error), and compositions of the layers are not actually measured. Results of measurement of various characteristics in the magnetoresistive effect film are shown in the following table. Switch connection magnetic field expressed as follow represents the magnetic field applied from the anti-ferromagnetic layer to the fixed magnetic layer. On the other hand, after a heat treatment means after heat treatment for four hours less than or equal to 4×10⁻⁵ Pa, at 260° C. in a magnetic field of 500 Oe. It should be noted that, as the buffer layer, Ta, Zr, Hf, W or the like may be used. As a material of the anti-ferromagnetic layer, NiMn, IrMn, PtPdMn, ReMn, PtMn, CrMn, Ni oxide, a mixture of Ni oxide and Co oxide, a mixture of Ni oxide and Fe oxide, two layer film of Ni oxide/Co oxide, two layer film of Ni oxide/Fe oxide and the like may be used other than FeMn.

TABLE 1

| Crystal Grain Size (nm) | 8.1 | 12.0 | 14.3 | 16.5 |
|---|---|---|---|---|
| MR Ratio (%) | 4.5 | 4.1 | 3.9 | 3.4 |
| Coercivity in Hard Axis | 2.1 | 2.8 | 3.2 | 3.8 |
| direction of NiFe Layer | | | | |
| 102/CoFe Layer 103 | | | | |
| Exchange Bias Field (Oe) | 210 | 232 | 251 | 304 |
| MR Ratio after Heat Treatment | 4.0 | 3.7 | 3.5 | 3.0 |

The magnetoresistive effect film having a construction shown in FIG. 6 is fabricated with employing a glass substrate of Corning 7059 (tradename) as the substrate 100, 8 nm of Ni₈₁Fe₁₉ as the NiFe layer, 2.5 nm of Cu as the non-magnetic layer 104, 0.4 nm of Co₉₀Fe₁₀ as the MR enhanced layer 105, 2.6 nm of Ni₈₁Fe₁₉ as the fixed magnetic layer 106, 30 nm of Ni₄₆Mn₅₄ as the anti-ferromagnetic layer 107, and 2.5 nm of Ta as the protective layer 108. Results of measurement of various characteristics in the magnetoresistive effect film are shown in the following table. On the other hand, after a heat treatment means after heat treatment for four hours less than or equal to 4×10⁻⁵ Pa, at 260° C. in a magnetic field of 500 Oe. It should be noted that, as the buffer layer, Ta, Zr, Hf, W or the like may be used. As a material of the anti-ferromagnetic layer, FeMn, IrMn, PtPdMn, ReMn, PtMn, CrMn, Ni oxide, a mixture of Ni oxide and Co oxide, a mixture of Ni oxide and Fe oxide, two layer film of Ni oxide/Co oxide, two layer film of Ni oxide/Fe oxide and the like may be used other than NiMn.

TABLE 2

| Crystal Grain Size (nm) | 10.3 | 11.4 | 12.6 | 13.1 |
|---|---|---|---|---|
| MR Ratio (%) | 3.0 | 2.9 | 2.5 | 2.2 |
| Coercivity in Hard Axis | 0.6 | 0.8 | 0.8 | 1.0 |
| direction of NiFe Layer | | | | |
| 102/CoFe Layer 103 | | | | |
| Exchange Bias Field (Oe) | 304 | 311 | 332 | 340 |
| MR Ratio after Heat Treatment | 2.7 | 2.7 | 2.3 | 2.2 |

The magnetoresistive effect film having a construction shown in FIG. 8 is fabricated with employing a glass substrate of Corning 7059 (tradename) as the substrate 100, 0.2 to 6.0 nm of Ta as the buffer layer, 8 nm of Ni₈₁Fe₁₉ as the NiFe layer, 2.5 nm of Cu as the non-magnetic layer 104, 3 nm of Co₉₀Fe₁₀ as the fixed magnetic layer 106, 10 nm of FeMn as the anti-ferromagnetic layer 107, and 2.5 nm of Ta as the protective layer 108. After a heat treatment means after heat treatment for four hours less than or equal to 4×10⁻⁵ Pa, at 260° C. in a magnetic field of 500 Oe. It should be noted that, as the buffer layer, Ta, Zr, Hf, W or the like may be used. As a material of the anti-ferromagnetic layer, NiMn, IrMn, PtPdMn, ReMn, PtMn, CrMn, Ni oxide, a mixture of Ni oxide and Co oxide, a mixture of Ni oxide and Fe oxide, two layer film of Ni oxide/Co oxide, two layer film of Ni oxide/Fe oxide and the like may be used other than FeMn.

TABLE 3

| Crystal Grain Size (nm) | 8.4 | 12.5 | 13.7 | 15.7 |
|---|---|---|---|---|
| MR Ratio (%) | 4.0 | 3.8 | 3.6 | 3.3 |
| Coercivity in Hard Axis | 0.6 | 0.8 | 1.0 | 1.0 |
| direction of NiFe Layer | | | | |
| 102/CoFe Layer 103 | | | | |
| Exchange Bias Field (Oe) | 213 | 240 | 250 | 294 |
| MR Ratio after Heat Treatment | 3.6 | 3.4 | 3.5 | 3.2 |

Next, embodiments, in which these magnetoresistive effect film is applied to a shield type element.

An element is fabricated the shield type element of the type shown in FIG. 2 employing the magnetoresistive effect film as set forth in the first aspect. At this time, NiFe is used as the lower shield layer and alumina is used as the lower gap layer. As the magnetoresistive effect film, Ta (3 nm)/Ni₈₂Fe₁₈ 7 nm)/Co₉₀Fe₁₀ (1 nm)/Cu (2.5 nm)/Co₉₀Fe₁₀ (3 nm)/Ni₄₆Mn₅₄ (30 nm)/Ta (3 nm) is used with processing into a size of 1×1 μm. CoCrPt and Mo lower electrode layer are stacked to contact with the end portion of the magnetoresistive effect film. Alumina is used as the upper gap layer and NiFe is used as the upper shield layer. The head is processed into the integrated type recording and reproducing head as shown in FIG. 3. Then, data is recorded on a CoCrTa type medium and reproduced therefrom. At this time, a writing track width is 1.5 μm, a reading gap is a 0.21 μm. A coercivity of the medium is 2.5 kOe. A reproduced output is measured by varying a recording bit length. A result of measurement shows as the following table.

TABLE 4

| Crystal Grain Size (nm) | 13.1 |
|---|---|
| Bit Length (Frequency) to Attenuate | 155 |
| Reproduction Output into Half (kFCl) | |
| Reproduction Output (peak-to-peak) (mV) | 1.5 |
| Symmetry of Wave | good |
| S/N (dB) | 26.1 |
| error rate | 10⁻⁶ or less |

An element is fabricated the shield type element of the type shown in FIG. 3 employing the magnetoresistive effect film as set forth in the first aspect. At this time, FeTaN is used as the lower shield layer and amorphous carbon is used as the lower gap layer. As the magnetoresistive effect film, Ta (3 nm)/Ni₈₂Fe₁₈ (7 nm)/Co₉₀Fe₁₀ (3 nm)/Cu (2.5 nm)/Co₉₀Fe₁₀ (3 nm) /Ni₄₆Mn₅₄ (30 nm)/Ta (3 nm) is used with PR etching processing into a size of 1×1 μm. CoCrPt and Mo lower electrode layer are stacked to contact with the end portion of the magnetoresistive effect film. Alumina is used as the upper gap layer and NiFe is used as the upper shield layer. The head is processed into the integrated type recording and reproducing head as shown in FIG. 4. Then, data is recorded on a CoCrTa type medium and reproduced therefrom. At this time, a writing track width is set at 1.5 μm, a writing gap is set at 0.2 μm, a reading track width is set at 1.0 μm and reading gap is set at 0.2 μm. A coercivity of the medium is set at 2.5 kOe. A reproduced output is measured by varying a recording bit length. A result of measurement shows as the following table.

TABLE 5

| Crystal Grain Size (nm) | 12.5 |
|---|---|
| Bit Length (Frequency) to Attenuate | 161 |
| Reproduction Output into Half (kFCl) | |
| Reproduction Output (peak-to-peak) (mV) | 1.7 |
| Symmetry of Wave | good |
| S/N (dB) | 26.1 |
| error rate | 10⁻⁶ or less |

On the other hand, environmental test at 80° C. and 500 Oe was performed for the head set forth above. However, error rate has not been changed for 2500 hours.

Also, excitation test for the head was performed under a condition of 2×10⁷ A/cm² of current density and 80° C. of environmental temperature. Then, no variation of both of resistance value and resistance variation rate have not been observed up to 1000 hours.

Next, discussion will be given for a magnetic disk drive experimentally produced with applying the present invention. The magnetic disk drive has three magnetic disks on a base. On a back surface of the base, a head driving circuit, a signal processing circuit and an input/output interface are received. The magnetic disk drive is externally connected to a 32 bit bus line. On both surface of the magnetic disks, six heads are arranged. A rotary actuator for driving the head, its driving and controlling circuit, and a disk driving spindle motor are mounted. A diameter of the disk is 46 mm, a data surface uses in an annular range from 10 mm to 40 mm diameter. Since buried servo type rotary actuator, the driving and controlling circuit and the disk driving spindle motor are employed, increasing of density becomes possible for no servo surface being required. The shown apparatus can be directly connected as an external storage device of a compact computer. A cache memory is mounted in an input interface for adapting to a bus line having a transfer speed of a range of 5 to 20 megabyte per second. On the other hand, by providing an external controller, a plurality of the apparatus of the shown embodiment are connected to form a magnetic disk drive of large storage capacity.

As set forth above, the present invention functions as follow. According to the present invention, the crystal grain size of the stacked film is set to be greater than or equal to 8 nm but less than or equal to total layer thickness of the stacked film except for the substrate and buffer layer. Thus, it becomes possible to provide the magnetoresistive effect film having high MR ratio even after heat treatment, superior in stability, high reproduction output, low noise level, high S/N ratio, low error rate, and furthermore achieving superior reliability of the element, the magnetoresistive effect sensor and the magnetic storage device utilizing the foregoing magnetoresistive effect film.

Although the present invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodied within a scope encompassed and equivalents thereof with respect to the feature set out in the appended claims.

What is claimed is:

1. A magnetoresistive effect film comprising a stacked film consisted of:
a substrate,
an buffer layer,
a NiFe layer,
a non-magnetic layer,
a fixed magnetic layer, and
an anti-ferromagnetic layer,
a crystal grain size of said stacked film being greater than or equal to 8 nm and less than or equal to a total layer thickness of said stacked layer excluding said substrate and said buffer layer.

2. A magnetoresistive effect film as set forth in claim 1, wherein said stacked layer is further consisted of a CoFe layer.

3. A magnetoresistive effect film as set forth in claim 1, wherein sad stacked layer is further consisted of a magnetoresistance enhanced layer.

4. A magnetoresistive effect film as set forth in claim 1, wherein said buffer layer contains at least one of Ta, Zr, Hf and W.

5. A magnetoresistive effect film as set forth in claim 4, wherein said stacked layer is further consisted of a CoFe layer.

6. A magnetoresistive effect film as set forth in claim 4, wherein sad stacked layer is further consisted of a magnetoresistance enhanced layer.

7. A magnetoresistive effect film as set forth in claim 3, wherein sad stacked layer is further consisted of a magnetoresistance enhanced layer.

8. A magnetoresistive effect film as set forth in claim 7, wherein said stacked layer is further consisted of a CoFe layer.

9. A magnetoresistive effect sensor comprising:
a substrate,
a lower shield layer,
a lower gap layer and
a magnetoresistive effect film of a stacked film consisted of a substrate, an buffer layer, a NiFe layer, a non-magnetic layer, a fixed magnetic layer, and an anti-ferromagnetic layer, and a crystal grain size of said stacked film being greater than or equal to 8 nm and less than or equal to a total layer thickness of said stacked layer excluding said substrate and said buffer layer,
said lower shield layer and said magnetoresistive effect film being patterned;
a longitudinal bias layer and a lower electrode layer being stacked at a position contacting with at least an end portion of said magnetoresistive effect film, in sequential order, and
an upper gap layer and an upper field being stacked on said longitudinal bias layer and said lower electrode layer in sequential order.

10. A magnetoresistive effect sensor as set forth in claim 9, wherein said stacked layer is further consisted of a CoFe layer.

11. A magnetoresistive effect sensor as set forth in claim 9, wherein sad stacked layer is further consisted of a magnetoresistance enhanced layer.

12. A magnetoresistive effect sensor as set forth in claim 9, wherein a gap defining insulation layer is disposed between said magnetoresistive effect film and said upper gap layer.

13. A magnetoresistive effect sensor as set forth in claim 10, wherein sad stacked layer is further consisted of a magnetoresistance enhanced layer.

14. A magnetoresistive effect sensor as set forth in claim 10, wherein a gap defining insulation layer is disposed between said magnetoresistive effect film and said upper gap layer.

15. A magnetoresistive effect sensor as set forth in claim 14, wherein sad stacked layer is further consisted of a magnetoresistance enhanced layer.

16. A magnetoresistive effect sensor comprising:
a substrate,
a lower shield layer,
a lower gap layer and
a magnetoresistive effect film of a stacked film consisted of a substrate, an buffer layer, a NiFe layer, a non-magnetic layer, a fixed magnetic layer, and an anti-ferromagnetic layer, and a crystal grain size of said stacked film being greater than or equal to 8 nm and less than or equal to a total layer thickness of said stacked layer excluding said substrate and said buffer layer,
said lower shield layer and said magnetoresistive effect film being patterned;
a longitudinal bias layer and a lower electrode layer being stacked at a position overlapping with a part of said magnetoresistive effect film, in sequential order, and
an upper gap layer and an upper field being stacked on said longitudinal bias layer and said lower electrode layer in sequential order.

17. A magnetoresistive effect sensor as set forth in claim 16, wherein said stacked layer is further consisted of a CoFe layer.

18. A magnetoresistive effect sensor as set forth in claim 16, wherein sad stacked layer is further consisted of a magnetoresistance enhanced layer.

19. A magnetoresistive effect sensor as set forth in claim 17, wherein sad stacked layer is further consisted of a magnetoresistance enhanced layer.

20. A magnetic storage device comprising:
a magnetic storage medium;
a magnetic head for recording and reproducing data in and from sad magnetic storage medium;
a positioning mechanism for positioning said magnetic head on a predetermined track of said magnetic storage medium; and
a control portion controlling respective components of said magnetic storage device, and
said magnetic head including a magnetoresistive effect sensor comprising a substrate, a lower shield layer, a lower gap layer and a magnetoresistive effect film of a stacked film consisted of a substrate, an buffer layer, a NiFe layer, a non-magnetic layer, a fixed magnetic layer, and an anti-ferromagnetic layer, and a crystal grain size of said stacked film being greater than or equal to 8 nm and less than or equal to a total layer thickness of said stacked layer excluding said substrate and said buffer layer, said lower shield layer and said magnetoresistive effect film being patterned, a longitudinal bias layer and a lower electrode layer being stacked at a position contacting with at least an end portion of said magnetoresistive effect film, in sequential order, and an upper gap layer and an upper field being stacked on said longitudinal bias layer and said lower electrode layer in sequential order.

21. A magnetic storage device comprising:
a magnetic storage medium;
a magnetic head for recording and reproducing data in and from sad magnetic storage medium;
a positioning mechanism for positioning said magnetic head on a predetermined track of said magnetic storage medium; and
a control portion controlling respective components of said magnetic storage device, and
said magnetic head including a magnetoresistive effect sensor comprising a substrate, a lower shield layer, a lower gap layer and a magnetoresistive effect film of a stacked film consisted of a substrate, an buffer layer, a NiFe layer, a non-magnetic layer, a fixed magnetic layer, and an anti-ferromagnetic layer, and a crystal grain size of said stacked film being greater than or equal to 8 nm and less than or equal to a total layer thickness of said stacked layer excluding said substrate and said buffer layer, said lower shield layer and said magnetoresistive effect film being patterned, a longitudinal bias layer and a lower electrode layer being stacked at a position overlapping with a part of said magnetoresistive effect film, in sequential order, and an upper gap layer and an upper field being stacked on said longitudinal bias layer and said lower electrode layer in sequential order.

22. A magnetic storage device as set forth in claim 20, wherein a gap defining insulation layer is disposed between said magnetoresistive effect film and said upper gap layer.
